(19) United States
(12) Patent Application Publication
(10) Pub. No.: US 2017/0153380 A1
(43) Pub. Date: Jun. 1, 2017

(54) LIQUID CRYSTAL DISPLAY DEVICE AND METHOD FOR MANUFACTURING LIGHT GUIDING PLATE THEREOF

(71) Applicants: Shenzhen China Star Optoelectronics Technology Co. Ltd., Shenzhen, Guangdong (CN); Wuhan China Star Optoelectronics Technology Co., Ltd., Wuhan, Hubei (CN)

(72) Inventors: Cong WANG, Shenzhen, Guangdong (CN); Peng DU, Shenzhen, Guangdong (CN)

(73) Assignees: Shenzhen China Star Optoelectronics Technology Co. Ltd., Shenzhen, Guangdong (CN); WUHAN CHINA STAR OPTOELECTRONICS TECHNOLOGY CO., LTD., Wuhan, Hubei (CN)

(21) Appl. No.: 14/768,813

(22) PCT Filed: Jul. 17, 2015
(86) PCT No.: PCT/CN2015/084322

§ 371 Date: Aug. 19, 2015

(30) Foreign Application Priority Data
Jul. 10, 2015 (CN) 201510407802.9

(51) Int. Cl. F21V 8/00; G02F 1/1335

(52) U.S. Cl. CPC G02B 6/0065; G02B 6/0091; G02B 6/0036; G02B 6/0038; G02B 6/0053; G02F 1/133514; G02F 2202/28

(57) ABSTRACT

The disclosure provides a liquid crystal display device and a method for manufacturing a light guiding plate thereof. Wherein, multiple first protrusions are disposed on an irradiating surface of the light guiding plate, a prism sheet of an optical film assembly is disposed adjacent with the light guiding plate, multiple of second protrusions are disposed on the prism sheet of the optical film assembly, the second protrusions and the first protrusions are alternatively arranged, and translucent adhesives are disposed between each of the first protrusions and two adjacent second protrusions, such that the prism sheet is fixed with the light guiding plate. The disclosure can improve the phenomena of Hotspot Mura when displaying and decrease the thickness of the backlight module, such that it is beneficial for the designs of narrow frame and non-frame of liquid crystal display devices.

### TECHNICAL FIELD

The disclosure is related to the field of liquid crystal display, and more particularly to a liquid crystal display device and a method for manufacturing a light guiding plate of the liquid crystal display device.

### RELATED ART

A backlight type of liquid crystal display (LCD) comprises a liquid crystal panel and a backlight module. As an edge light backlight module, a backlight source is disposed at the edge of a back plate, which is behind the liquid crystal panel, the light emitted from the backlight source enters a light guiding plate (LGP) through an incident surface of the light guiding plate, the light is emitted from an irradiating surface of the light guiding plate after reflection and diffusion, and a surface light source is formed by an optical film assembly and then is provided to the liquid crystal panel. In order to ensure the displaying quality of the liquid crystal display device, it is important to ensure that the light emitted from the backlight source is sufficiently mixed. Specifically, the distance between the backlight source and the display region of the liquid crystal panel should meet the requirement of assembling. However, errors cannot be avoided in real practice of assembling, such that the distance between the backlight source and the display region is shorter than the requirement. Thus, the distance between the backlight source and the incident surface of the light guiding plate is short, such that the light emitted from the backlight source cannot be mixed sufficiently and differences of brightness and color occur, and it further causes Hotspot Mura (the brightness is not uniform) when displaying.

### SUMMARY

Accordingly, the disclosure provides a liquid crystal display device and a method for manufacturing a light guiding plate thereof so as to improve the phenomena of Hotspot Mura when displaying.

According to an embodiment of the disclosure, a liquid crystal display device is provided. The liquid crystal display device comprises a backlight source, a back plate, a light guiding plate disposed on the back plate, an optical film assembly disposed on the light guiding plate, a liquid crystal panel disposed on the optical film assembly, and a frame surrounding the light guiding plate and pressing and fixing the liquid crystal panel to the optical film assembly, wherein the backlight source is disposed between the frame and a lateral surface of the light guiding plate, and the lateral surface of the light guiding plate is an incident surface of the light guiding plate. Wherein the material of the light guiding plate is glass, a plurality of first protrusions is disposed on an irradiating surface of the light guiding plate, a bottom surface of a prism sheet of the optical film assembly is disposed adjacent with the light guiding plate, a plurality of second protrusions is disposed on the bottom surface of the prism sheet of the optical film assembly, the plurality of second protrusions and the plurality of first protrusions are alternatively arranged, translucent adhesives are disposed between each of the first protrusions and two adjacent second protrusions, such that the bottom surface of the prism sheet is fixed with the irradiating surface of the light guiding plate by the translucent adhesive, and a top surface of the optical film assembly is fixed with the liquid crystal panel by the translucent adhesive.

Wherein the light guiding plate has a groove, a bottom surface of the groove is the irradiating surface of the light guiding plate, a sidewall of the groove is parallel to the incident surface of the light guiding plate, and the sidewall of the groove and the incident surface of the light guiding plate are separated by a predetermined thickness.

Wherein the groove and the plurality of first protrusions are integrally formed, and the groove and the plurality of first protrusions are formed by etching a rectangular glass substrate by an acid liquid.

Wherein the liquid crystal panel comprises an array substrate and a color film substrate, the color film substrate is disposed closed to the optical film assembly, and an edge of the color film substrate is disposed in the groove, the liquid crystal display device further comprises a shading tape, such that the color film substrate is relatively fixed with the light guiding plate, one edge of the shading tape abuts the frame, another edge of the shading tape abuts or overlaps with an edge of the optical film assembly, one end of the frame is fixed to the back plate, and another end of the frame is fixed with the array substrate and flushes with an edge of the array substrate.

According to another embodiment of the disclosure, a liquid crystal display device is provided. The liquid crystal display device comprises a back plate, a light guiding plate disposed on the back plate, an optical film assembly disposed on the light guiding plate, a liquid crystal panel disposed on the optical film assembly, and a frame surrounding the light guiding plate and pressing and fixing the liquid crystal panel to the optical film assembly. Wherein a plurality of first protrusions is disposed on an irradiating surface of the light guiding plate, a bottom surface of the optical film assembly is disposed adjacent with the light guiding plate, a plurality of second protrusions is disposed on the bottom surface of the optical film assembly, the plurality of second protrusions and the plurality of first protrusions are alternatively arranged, translucent adhesives are disposed between each of the first protrusions and two adjacent second protrusions, such that the bottom surface of the optical film assembly is fixed with the irradiating surface of the light guiding plate by the translucent adhesive.

Wherein the liquid crystal display device further comprises a backlight source, the backlight source is disposed between the frame and a lateral surface of the light guiding plate, and the lateral surface of the light guiding plate is an incident surface of the light guiding plate.

Wherein the optical film assembly comprises a prism sheet, and the prism sheet comprises the plurality of second protrusions.

Wherein the material of the light guiding plate is glass or polycarbonate.

Wherein the light guiding plate has a groove, a bottom surface of the groove is the irradiating surface of the light guiding plate, a sidewall of the groove is parallel to the incident surface of the light guiding plate, and the sidewall of the groove and the incident surface of the light guiding plate are separated by a predetermined thickness.

Wherein the groove and the plurality of first protrusions are integrally formed, and the groove and the plurality of first protrusions are formed by etching a rectangular glass substrate by an acid liquid.

Wherein the liquid crystal panel comprises an array substrate and a color film substrate, the color film substrate is disposed closed to the optical film assembly, and an edge of the color film substrate is disposed in the groove, the liquid crystal display device further comprises a shading tape, such that the color film substrate is relatively fixed with the light guiding plate, one edge of the shading tape abuts the frame, another edge of the shading tape abuts or overlaps with an edge of the optical film assembly, one end of the frame is fixed to the back plate, and another end of the frame is fixed with the array substrate and flushes with an edge of the array substrate.

Wherein a top surface of the optical film assembly is fixed with the liquid crystal panel by the translucent adhesive.

According to another embodiment of the disclosure, a method for manufacturing a light guiding plate of a liquid crystal display device is provided. The liquid crystal display device comprises a back plate supporting the light guiding plate, an optical film assembly disposed on the light guiding plate, a liquid crystal panel disposed on the optical film assembly, and a frame surrounding the light guiding plate and pressing and fixing the liquid crystal panel to the optical film assembly, wherein a plurality of first protrusions is disposed on an irradiating surface of the light guiding plate, a bottom surface of the optical film assembly is disposed adjacent with the light guiding plate, a plurality of second protrusions is disposed on the bottom surface of the optical film assembly, the plurality of second protrusions and the plurality of first protrusions are alternatively arranged, translucent adhesives are disposed between each of the first protrusions and two adjacent second protrusions, such that the bottom surface of the optical film assembly is fixed with the irradiating surface of the light guiding plate by the translucent adhesive. The method comprises: forming a plurality of grid points having a predetermined shape on a surface of two glass substrates respectively; coating a sealant on another surface opposite to the region of the plurality of grid points on one of the two glass substrates, and aligning the two glass substrates by the sealant; etching another surface of the two glass substrates respectively, such that a groove being formed on the two glass substrates respectively, and a plurality of protrusions being formed on a bottom surface of the grooves.

Wherein before the step of etching another surface of the two glass substrates respectively, the method further comprises: coating a corrosion resistant layer on another surface of the two glass substrates, and the corrosion resistant layer being disposed outside the region of the plurality of grid points; separating the two glass substrates.

According to the liquid crystal display device and the method for manufacturing the light guiding plate thereof of the disclosure, the irradiating surface of the light guiding plate has the plurality of first protrusions, the bottom surface of the optical film assembly has the plurality of second protrusions, the plurality of second protrusions and the plurality of first protrusions are alternatively arranged, and the translucent adhesives are disposed between the first protrusions and the second protrusions, such that the optical film assembly is fixed with the light guiding plate. Since the light guiding plate and the backlight source are fixed relatively to the back plate as well as the liquid crystal panel is disposed corresponding to the optical film assembly, such that the relative position between the liquid crystal panel and the backlight source are fixed. Thus, the distance between the backlight source and the display region of the liquid crystal panel meets the requirement of assembling, such that the distance between the backlight source and the incident surface of the light guiding plate meets the requirement. Therefore, it can ensure that the light emitted from the backlight source be sufficiently mixed and the phenomena of Hotspot Mura can be improved.

### BRIEF DESCRIPTION OF THE DRAWINGS

In order to more clearly illustrate the embodiments of the disclosure, the accompanying drawings for illustrating the technical solutions and the technical solutions of the disclosure are briefly described as below.

FIG. 1 is a schematic view of the liquid crystal display device according to an embodiment the disclosure;

FIG. 2 is a flow chart of the method for manufacturing the glass light guiding plate according to an embodiment the disclosure;

FIG. 3 is a schematic view of the plurality of gird points formed on the glass substrate according to the disclosure;

FIG. 4 is a schematic view of the two glass substrates are with each other according to the disclosure;

FIG. 5 is a schematic view of the first protrusions formed by etching the two glass substrates according to the disclosure;

FIG. 6 is a schematic view of the light guiding plate obtained by separating the two glass substrates according to the disclosure; and

FIG. 7 is a schematic view of the liquid crystal display according to another embodiment of the disclosure.

### DETAILED DESCRIPTION

The following description with reference to the accompanying drawings is provided to clearly and completely explain the exemplary embodiments of the disclosure. It is apparent that the following embodiments are merely some embodiments of the disclosure rather than all embodiments of the disclosure. According to the embodiments in the disclosure, all the other embodiments attainable by those skilled in the art without creative endeavor belong to the protection scope of the disclosure.

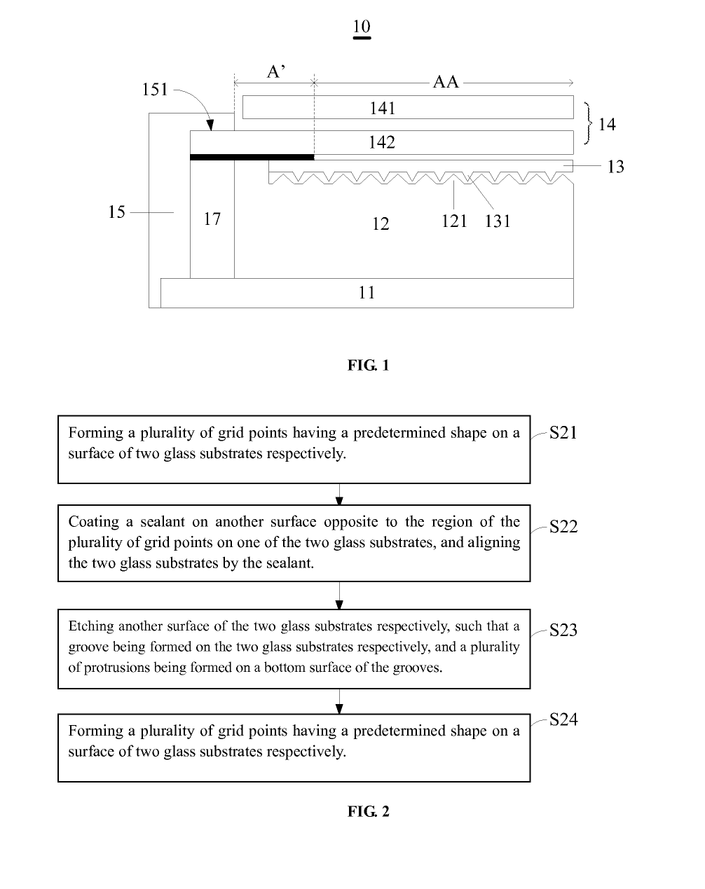

FIG. 1 is a schematic view of the liquid crystal display device according to an embodiment the disclosure. As shown in FIG. 1, the liquid crystal display device 10 comprises a backlight module and a liquid crystal panel 14. The backlight module comprises a back plate 11, a light guiding plate 12 disposed on the back plate 11, an optical film assembly 13 disposed on the light guiding plate 12, a liquid crystal panel 14 disposed on the optical film assembly 13, and a frame 15 surrounding the light guiding plate 12 and pressing and fixing the liquid crystal panel 14 to the optical film assembly 13, wherein the liquid crystal panel 14 comprises a color film substrate 141 and an array substrate 142, the array substrate 142 is disposed adjacent with the optical film assembly 13, the frame 15 has a groove 151 and presses and fixed the liquid crystal panel 14 by the groove 151, a plurality of first protrusions 121 is disposed on an irradiating surface of the light guiding plate 121, the optical film assembly 13 comprises a prism sheet and other optical films, a bottom surface of the prism sheet is disposed adjacent with the irradiating surface of the light guiding plate 12, and a plurality of second protrusions 131 is disposed on the bottom surface of the prism sheet.

According to the embodiment, the liquid crystal display device 10 can be an edge light liquid crystal display device as shown in the figure, i.e. a backlight source 17 of the liquid crystal display device 10 is disposed between the frame 15 and a lateral surface of the light guiding plate 12. The lateral surface of the light guiding plate 12 is an incident surface of the light guiding plate 12, and the lateral surface of the light guiding plate 12 is perpendicular with the irradiating surface. Wherein, the backlight source 17 can be a LED light bar. However, in some other embodiments, the liquid crystal display device 10 can be a bottom light liquid crystal display device, i.e. the backlight source 17 is disposed between the back plate 11 and a bottom surface of the light guiding plate 12. In those embodiments, the bottom surface of the light guiding plate 12 is the incident surface of the light guiding plate 12, and the bottom surface of the light guiding plate 12 is opposite to the irradiating surface.

When assembling the liquid crystal display device 10, the plurality of second protrusions 131 and the plurality of first protrusions 121 are alternatively arranged, translucent adhesives are disposed between each of the first protrusions 121 and two adjacent second protrusions 131. For example, the translucent adhesives can be OCA (Optically Clear Adhesive, a special translucent adhesive). Thus, the bottom surface of the prism sheet is fixed with the irradiating surface of the light guiding plate 12 by the translucent adhesive. Since the light guiding plate 12 and the backlight source 17 are relatively fixed with the back plate 11, and the liquid crystal panel 14 is disposed corresponding to the prism sheet, the liquid crystal panel 14 is also fixed with a top surface of the optical film assembly 13 by the translucent adhesive, such that the distance between the liquid crystal panel 14 and the backlight source 17 is fixed. Thus, the distance A′ between the backlight source 17 and the active area (AA) of the liquid crystal panel 14 equals to the distance of the requirement, and the distance would not be shorter because of the errors caused in assembling. Thus, the distance between the backlight source 17 and the incident surface of the light guiding plate 12 meets the requirement. Therefore, it can ensure that the light emitted from the backlight source 17 can be sufficiently mixed, the differences of brightness and color can be greatly decreased, as well as the phenomena of Hotspot Mura when displaying can be improved.

In other words, based on the combination of present liquid crystal display devices, which cannot avoid the phenomena of Hotspot Mura, and common knowledge in the technical field that the phenomena of Hotspot Mura would become worse when the ratio of the distance between the backlight source and the display region of the liquid crystal panel to the distance between two LEDs on the backlight source is smaller, one can understand that the embodiment can greatly increase the distance between LEDs on the backlight source 17, such that the amount of LEDs on the backlight source 17 can be decreased and the cost can be lowered.

Referring to FIG. 1 again, the material of the light guiding plate 12 can be polycarbonate (PC or engineering plastics), which is like the present technique. In some other embodiments, the material of the light guiding plate 12 can be glass. Since the diffusion of light in glass is better than PC, a point light source should be converted to a face light source as well as the same uniformity should be achieved. The path of refraction of the glass light guiding plate 12 is shorter than the path of refraction of the PC light guiding plate 12, such that the thickness of the light guiding plate 12 can be decreased when glass is used, and the thickness of the backlight module can be decreased.

FIG. 2 is a flow chart of the method for manufacturing the glass light guiding plate according to an embodiment the disclosure. As shown in FIG. 2, the method for manufacturing the glass light guiding plate 12 comprises:

Step S21: forming a plurality of grid points having a predetermined shape on a surface of two glass substrates respectively.

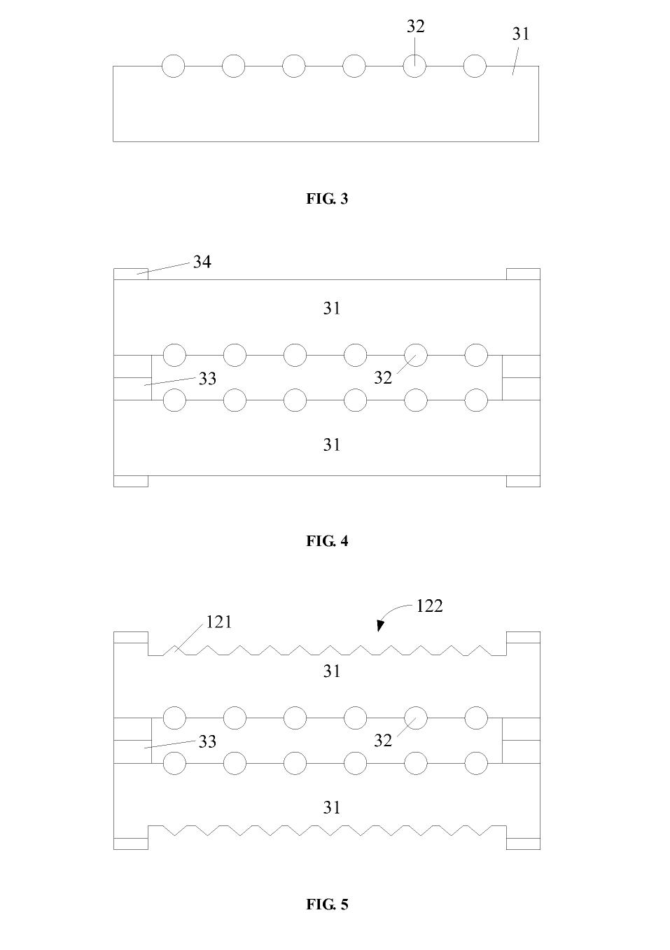

Also referring to FIG. 3, a plurality of protruded and transparent grid points (frequency adjusting points or light diffusion points) having identical sizes can be printed on the two transparent glass substrates 31 by screen printing, wherein the grid points 32 can be ball-shaped as shown in the figure, or square-shaped.

Step S22: coating a sealant on another surface opposite to the region of the plurality of grid points on one of the two glass substrates, and aligning the two glass substrates by the sealant.

Also referring to FIG. 4, a sealant 33 is coated outside the region of the plurality of grid points 32, i.e. the sealant 33 is disposed at the edge of the two glass substrates 31. When the two glass substrates 31 are aligned with each other, the sealant 33 can seal the two glass substrates 31.

Step S23: etching another surface of the two glass substrates respectively, such that a groove being formed on the two glass substrates respectively, and a plurality of protrusions being formed on a bottom surface of the grooves.

Also referring to FIG. 5, the two glass substrates 31 can be dipped into a HF (hydrofluoric acid) solution, such that a plurality of first protrusions 121 can be formed by etching.

In order to avoid the liquid crystal panel 14 directly pressing to the optical film assembly 13 and damaging the fragile optical film assembly 13, the light guiding plate 12 in this embodiment can further has a groove 122 as shown in FIGS. 1 and 5, such that a predetermined thickness between the groove 122 and the incident surface of the light guiding plate 12 can support the liquid crystal panel 14, the optical film assembly 13 can be disposed in the groove 122, as well as the plurality of first protrusions 121 can be disposed on the bottom surface of the groove 122. Wherein, the groove 122 and the plurality of first protrusions 121 can be integrally formed, i.e. the groove 122 and the plurality of first protrusions 121 are obtained by etching the rectangular glass substrate 31 by an acid solution. Specifically, before the step of etching another surface of the two glass substrates 31 respectively, as shown in FIG. 4, a corrosion resistant layer 34 can be coated on another surface of the two glass substrates 31, wherein the corrosion resistant layer 34 is disposed outside the region of the plurality of grid points 32. While forming the plurality of first protrusions 121 by etching, the region which is covered by the corrosion resistant layer 34 would not be etched. The material of the corrosion resistant layer 34 can be identical with the material of the sealant 33, for example, thermoplastic sealant. In some other embodiments, the corrosion resistant layer 34 can be made by other materials.

Step S24: separating the two glass substrates.

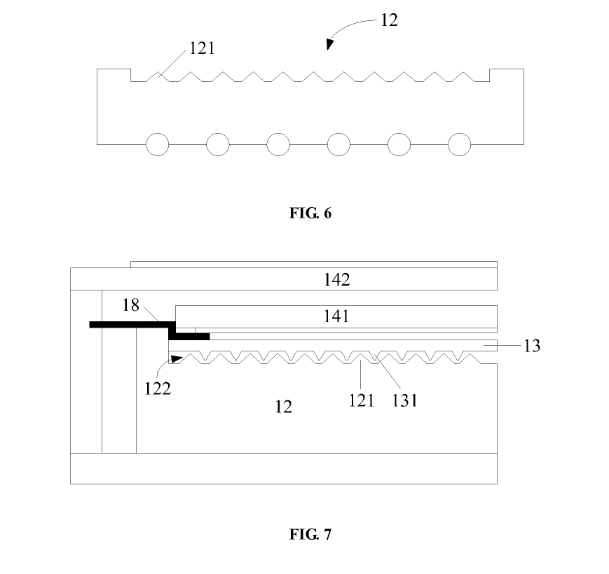

Referring to FIGS. 5 and 6, the two glass substrates 31 can be heated, such that the thermoplastic sealant 33 can be softened. Then, the two glass substrates 31 are separated and the light guiding plate 12 is obtained. When the size of the two glass substrates 31 are larger than the expected size, the two glass substrates 31 can be cut in advance, such that the size of the glass substrate 31 after cutting can meet the requirement of the light guiding plate 12, and then they are separated under heating.

FIG. 7 is a schematic view of the liquid crystal display according to another embodiment of the disclosure. The difference between the above embodiment and this embodiment is that the color film substrate 141 is disposed adjacent with the optical film assembly 13 (or the light guiding plate 12), and an edge of the color film substrate 141 is supported in the groove 122 of the light guiding plate 12. In addition, one edge of the shading tape 18, which can shade light, abuts the frame 15, and another edge of the shading tape 18 abuts or overlaps with an edge of the optical film assembly 13, such that it can prevent the outer lead bonding (OLB) of the liquid crystal display device 10 from leaking light, and the color film substrate 141 can be fixed with the light guiding plate 12 by the adhesives of the shading tape 18. Thus, the liquid crystal panel 14 can be fixed to the irradiating surface of the light guiding plate 12 while the frame 15 does not need the groove 151 as shown in FIG. 1. Accordingly, the frame 15 flushes with the edge of the array substrate 142, such that the thickness of the frame 15 can be greatly decreased and it is beneficial for the designs of narrow frame and non-frame of liquid crystal display devices 10.

It should be noticed that the liquid crystal display devices in FIGS. 1 and 7 are used for exemplify the embodiments of the disclosure, and other embodiments can be referred with present technique.

Note that the specifications relating to the above embodiments should be construed as exemplary rather than as limitative of the present disclosure. The equivalent variations and modifications on the structures or the process by reference to the specification and the drawings of the disclosure, or application to the other relevant technology fields directly or indirectly should be construed similarly as falling within the protection scope of the disclosure.

What is claimed is:

1. A liquid crystal display device, comprising:
a backlight source;
a back plate;
a light guiding plate, disposed on the back plate;
an optical film assembly, disposed on the light guiding plate;
a liquid crystal panel, disposed on the optical film assembly; and
a frame, surrounding the light guiding plate and pressing and fixing the liquid crystal panel to the optical film assembly, wherein the backlight source is disposed between the frame and a lateral surface of the light guiding plate, and the lateral surface of the light guiding plate is an incident surface of the light guiding plate;
wherein the material of the light guiding plate is glass, a plurality of first protrusions is disposed on an irradiating surface of the light guiding plate, a bottom surface of a prism sheet of the optical film assembly is disposed adjacent with the light guiding plate, a plurality of second protrusions is disposed on the bottom surface of the prism sheet of the optical film assembly, the plurality of second protrusions and the plurality of first protrusions are alternatively arranged, translucent adhesives are disposed between each of the first protrusions and two adjacent second protrusions, such that the bottom surface of the prism sheet is fixed with the irradiating surface of the light guiding plate by the translucent adhesive, and a top surface of the optical film assembly is fixed with the liquid crystal panel by the translucent adhesive.

2. The liquid crystal display device according to claim 1, wherein the light guiding plate has a groove, a bottom surface of the groove is the irradiating surface of the light guiding plate, a sidewall of the groove is parallel to the incident surface of the light guiding plate, and the sidewall of the groove and the incident surface of the light guiding plate are separated by a predetermined thickness.

3. The liquid crystal display device according to claim 2, wherein the groove and the plurality of first protrusions are integrally formed, and the groove and the plurality of first protrusions are formed by etching a rectangular glass substrate by an acid liquid.

4. The liquid crystal display device according to claim 2, wherein the liquid crystal panel comprises an array substrate and a color film substrate, the color film substrate is disposed closed to the optical film assembly, and an edge of the color film substrate is disposed in the groove, the liquid crystal display device further comprises a shading tape, such that the color film substrate is relatively fixed with the light guiding plate, one edge of the shading tape abuts the frame, another edge of the shading tape abuts or overlaps with an edge of the optical film assembly, one end of the frame is fixed to the back plate, and another end of the frame is fixed with the array substrate and flushes with an edge of the array substrate.

5. A liquid crystal display device, comprising:
a back plate;
a light guiding plate, disposed on the back plate;
an optical film assembly, disposed on the light guiding plate;
a liquid crystal panel, disposed on the optical film assembly; and
a frame, surrounding the light guiding plate and pressing and fixing the liquid crystal panel to the optical film assembly;
wherein a plurality of first protrusions is disposed on an irradiating surface of the light guiding plate, a bottom surface of the optical film assembly is disposed adjacent with the light guiding plate, a plurality of second protrusions is disposed on the bottom surface of the optical film assembly, the plurality of second protrusions and the plurality of first protrusions are alternatively arranged, translucent adhesives are disposed between each of the first protrusions and two adjacent second protrusions, such that the bottom surface of the optical film assembly is fixed with the irradiating surface of the light guiding plate by the translucent adhesive.

6. The liquid crystal display device according to claim 5, wherein the liquid crystal display device further comprises a backlight source, the backlight source is disposed between the frame and a lateral surface of the light guiding plate, and the lateral surface of the light guiding plate is an incident surface of the light guiding plate.

7. The liquid crystal display device according to claim 5, wherein the optical film assembly comprises a prism sheet, and the prism sheet comprises the plurality of second protrusions.

8. The liquid crystal display device according to claim 5, wherein the material of the light guiding plate is glass or polycarbonate.

9. The liquid crystal display device according to claim 8, wherein the light guiding plate has a groove, a bottom surface of the groove is the irradiating surface of the light guiding plate, a sidewall of the groove is parallel to the incident surface of the light guiding plate, and the sidewall of the groove and the incident surface of the light guiding plate are separated by a predetermined thickness.

10. The liquid crystal display device according to claim 9, wherein the groove and the plurality of first protrusions are integrally formed, and the groove and the plurality of first protrusions are formed by etching a rectangular glass substrate by an acid liquid.

11. The liquid crystal display device according to claim 9, wherein the liquid crystal panel comprises an array substrate and a color film substrate, the color film substrate is disposed closed to the optical film assembly, and an edge of the color film substrate is disposed in the groove, the liquid crystal display device further comprises a shading tape, such that the color film substrate is relatively fixed with the light guiding plate, one edge of the shading tape abuts the frame, another edge of the shading tape abuts or overlaps with an edge of the optical film assembly, one end of the frame is fixed to the back plate, and another end of the frame is fixed with the array substrate and flushes with an edge of the array substrate.

12. The liquid crystal display device according to claim 5, wherein a top surface of the optical film assembly is fixed with the liquid crystal panel by the translucent adhesive.

13. A method for manufacturing a light guiding plate of a liquid crystal display device, wherein the liquid crystal display device comprises a back plate supporting the light guiding plate, an optical film assembly disposed on the light guiding plate, a liquid crystal panel disposed on the optical film assembly, and a frame surrounding the light guiding plate and pressing and fixing the liquid crystal panel to the optical film assembly, wherein a plurality of first protrusions is disposed on an irradiating surface of the light guiding plate, a bottom surface of the optical film assembly is disposed adjacent with the light guiding plate, a plurality of second protrusions is disposed on the bottom surface of the optical film assembly, the plurality of second protrusions and the plurality of first protrusions are alternatively arranged, translucent adhesives are disposed between each of the first protrusions and two adjacent second protrusions, such that the bottom surface of the optical film assembly is fixed with the irradiating surface of the light guiding plate by the translucent adhesive, wherein the method comprises:
forming a plurality of grid points having a predetermined shape on a surface of two glass substrates respectively;
coating a sealant on another surface opposite to the region of the plurality of grid points on one of the two glass substrates, and aligning the two glass substrates by the sealant;
etching another surface of the two glass substrates respectively, such that a groove being formed on the two glass substrates respectively, and a plurality of protrusions being formed on a bottom surface of the grooves; and
separating the two glass substrates.

14. The method according to claim 13, wherein before the step of etching another surface of the two glass substrates respectively, the method further comprises:
coating a corrosion resistant layer on another surface of the two glass substrates, and the corrosion resistant layer being disposed outside the region of the plurality of grid points.
